(19) United States
(12) Patent Application Publication
(10) Pub. No.: US 2026/0285026 A1
(43) Pub. Date: Sep. 24, 2026

(54) THREADLIKE ADHESIVE STICKING APPARATUS AND METHOD OF STICKING THREADLIKE ADHESIVE

(71) Applicant: NITTO DENKO CORPORATION, Ibaraki-shi, Osaka (JP)

(72) Inventors: Shigeki ISHIGURO, Ibaraki-shi, Osaka (JP); Yosuke MAKIHATA, Ibaraki-shi, Osaka (JP); Kayo SHIMOKAWA, Ibaraki-shi, Osaka (JP)

(21) Appl. No.: 19/469,963

(22) PCT Filed: Mar. 27, 2024
(86) PCT No.: PCT/JP2024/012540

§ 371 Date: Sep. 26, 2025

(30) Foreign Application Priority Data
Mar. 29, 2023 (JP) 2023-054109

(51) Int. Cl. B32B 39/00; B32B 37/10

(52) U.S. Cl. CPC B32B 39/00; B32B 37/10; B32B 2309/12

(57) ABSTRACT

A threadlike adhesive sticking apparatus includes a nozzle having an inner wall surface defining a cylindrical internal space and a tip end having a tip end opening at one end of the inner wall surface, the tip end opening allowing the cylindrical internal space to communicate with an outside, a peripheral portion surrounding the tip end opening at the tip end functions as a pressing unit that presses a threadlike adhesive, which is allowed to pass through the cylindrical internal space and is led out to the outside from the tip end opening, against an object W, and a value obtained by multiplying a thickness A of a surface functioning as the pressing unit of the peripheral portion and a numerical value 0.6 times a diameter B of a smallest-diameter portion of the tip end opening is 0.3 mm² or more and 3.0 mm² or less.

### TECHNICAL FIELD

The present invention relates to a threadlike adhesive sticking apparatus and a method of sticking a threadlike adhesive.

### BACKGROUND ART

An adhesive body such as an adhesive sheet and an adhesive tape is used for bonding various adherends such as metal, glass, wood, paper, cardboard, and plastic materials. For example, in a case of a wound form such as a roll-shaped adhesive tape, a base material of which a rear surface to be brought into contact with an adhesive surface is subjected to a releasing treatment is used in order to facilitate rewinding.

As an adhesive tape sticking apparatus, there is an apparatus in which an adhesive tape pulled out of a tip end of a holder for storing a roll-shaped adhesive tape is pressed against an adherend by a roller provided at the tip end while the holder is moved to pull out and stick the adhesive tape to the adherend (see Patent Literatures 1 and 2). There is also an adhesive tape sticking apparatus in which an adhesive tape pulled out of a hole at a tip end of a holder for storing the adhesive tape is stuck to an adherend by using a peripheral wall surrounding the hole, and is stuck to the adherend (see Patent Literature 3). Furthermore, there is also a sticking apparatus in which a threadlike adhesive led out of a tip end opening of a nozzle to the outside is pressed against an object by a peripheral portion of the tip end opening (see Patent Literatures 4 and 5).

### CITATION LIST

### Patent Literature

Patent Literature 1: JPS60-44463A
Patent Literature 2: JP2016-74538A
Patent Literature 3: JPH03-119083A
Patent Literature 4: JP2021-161404A
Patent Literature 5: JP2021-161406A

### SUMMARY OF INVENTION

### Technical Problem

However, since the sticking apparatuses described in Patent Literatures 1 and 2 press and stick the adhesive tape by the roller, the adhesive tape may release from the roller or deviate within a width of the roller. Therefore, a sticking accuracy is not excellent and it is difficult to make small turns. If the adhesive tape is tried to be stuck in a curved shape, the adhesive tape may twist and cannot be stuck properly.

In the sticking apparatus described in Patent Literature 3, before the adhesive tape is fed out of a leading unit, an orientation of the adhesive tape is aligned by using a roller provided in the leading unit. That is, since the tip end portion that contributes to sticking is only one side, which presses against a side without an adhesive layer of the base material of the adhesive tape, of the peripheral wall surrounding a rectangular hole, only a straight line can be drawn. The adhesive tape may deviate within a width of the rectangular hole.

On the other hand, the sticking apparatuses described in Patent Literatures 4 and 5 make a plurality of locations of the peripheral portion of the tip end opening of the nozzle function as a pressing unit. Accordingly, the sticking apparatuses described in Patent Literatures 4 and 5 can accurately stick the threadlike adhesive along any path without using a roller, and can solve the above problems of the sticking apparatuses described in Patent Literatures 1 to 3.

However, in a sticking apparatus that presses and sticks an adhesive such as an adhesive tape onto an object which is an adherend, if a pushing force of the adhesive against the object is small, the adhesive repulses and is likely to peel off from the object. In addition, if the pushing force of the adhesive against the object is too large, a friction force with the adhesive increases, sticking the adhesive to the object becomes difficult. Therefore, it is desirable to press the adhesive against the object with an appropriate pushing force. In this regard, the above Patent Literatures 4 and 5 disclose that the peripheral portion of the tip end opening of the nozzle functions as the pressing unit, but there is no description of a thickness of the peripheral portion functioning as the pressing unit, and the pushing force by the pressing unit is not considered, and thus there is room for improvement.

The present invention has been made in view of the above-described circumstances, and an object of the present invention is to provide a threadlike adhesive sticking apparatus and a method of sticking a threadlike adhesive, by which a threadlike adhesive can be accurately and smoothly stuck to any path.

### Solution to Problem

The above object of the present invention can be achieved by the following configuration.

(1) A threadlike adhesive sticking apparatus including:
a nozzle having an inner wall surface defining a cylindrical internal space and a tip end having a tip end opening at one end of the inner wall surface, the tip end opening allowing the internal space to communicate with an outside, in which
a peripheral portion surrounding the tip end opening at the tip end functions as a pressing unit that presses a threadlike adhesive, which is allowed to pass through the internal space and is led out to the outside from the tip end opening, against an object, and
a value obtained by multiplying a thickness of a surface functioning as the pressing unit of the peripheral portion and a numerical value 0.6 times a diameter of a smallest-diameter portion of the tip end opening is 0.3 mm² or more and 3.0 mm² or less.

According to the threadlike adhesive sticking apparatus having the configuration in above (1), the value obtained by multiplying the thickness of the surface functioning as the pressing unit that presses a threadlike adhesive to an object of the peripheral portion of the nozzle and the numerical value 0.6 times the diameter of the smallest-diameter portion of the tip end opening is 0.3 mm² or more and 3.0 mm² or less. In this way, an initial adhesive force of the threadlike adhesive to the object is easily obtained, and the threadlike adhesive can be stuck to the object without peeling even with a small pushing force. Even if the pushing force is large, a pressure on the threadlike adhesive is reduced, and a friction force with the threadlike adhesive can be reduced. Therefore, even if a surface of the object varies in height or the object is made of a material with low adhesive force, the threadlike adhesive can be stuck well to the object.

(2) The threadlike adhesive sticking apparatus according to (1), further including:
a nozzle displacement unit attached to the nozzle and configured to displace the nozzle by being displaced in a pressing direction; and
an absorption mechanism configured to absorb a displacement of the nozzle with respect to a displacement of the nozzle displacement unit in the pressing direction.

According to the threadlike adhesive sticking apparatus having the configuration in above (2), even if the nozzle is lowered instantaneously, the nozzle is gently lowered by the absorption mechanism. Accordingly, an adhesive force of the threadlike adhesive at a desired location can be increased by appropriately increasing a force with which the nozzle presses the threadlike adhesive. By not moving a plane position of the nozzle while pressing the nozzle, it is possible to increase a pressing time of the threadlike adhesive and to increase the adhesive force of the threadlike adhesive at the desired position.

Therefore, in a case where the threadlike adhesive is stuck while being fed out, the threadlike adhesive can be increased in the adhesive force and can be prevented from being peeled off by lowering the nozzle or pressing and stopping the nozzle for a few seconds at a start point (initial stage of sticking) of a predetermined path, a start point or an end point of a curve included in the predetermined path, a vertex of a corner included in the predetermined path, or the like.

(3) The threadlike adhesive sticking apparatus according to (1), in which
a value obtained by multiplying the thickness of the surface functioning as the pressing unit of the peripheral portion and a numerical value 1.5 times an average outer diameter of the threadlike adhesive is 0.3 mm² or more and 3.0 mm² or less.

According to the threadlike adhesive sticking apparatus having the configuration in above (3), the value obtained by multiplying the thickness of the surface functioning as the pressing unit of the peripheral portion and the numerical value 1.5 times the average outer diameter of the threadlike adhesive is 0.3 mm² or more and 3.0 mm² or less, so that a pushing area of the threadlike adhesive on the object is within an appropriate range. Accordingly, the initial adhesive force of the threadlike adhesive to the object can be more easily obtained, and the threadlike adhesive can be stuck well to the object, particularly in the initial stage of sticking.

(4) The threadlike adhesive sticking apparatus according to (1), in which
the thickness of the surface functioning as the pressing unit of the peripheral portion is 0.5 mm or more and 10.0 mm or less.

According to the threadlike adhesive sticking apparatus having the configuration in above (4), the thickness of the surface functioning as the pressing unit of the peripheral portion is set to 0.5 mm or more and 10.0 mm or less. Accordingly, it is possible to reduce floating of the threadlike adhesive due to repulsion when the nozzle is pushed while obtaining a good initial adhesive force of the threadlike adhesive to the object W, thereby enabling the threadlike adhesive to be well stuck to the object.

(5) The threadlike adhesive sticking apparatus according to (1), in which
a length of the smallest-diameter portion is 1 mm or more and less than 30 mm.

According to the threadlike adhesive sticking apparatus having the configuration in above (5), the length of the smallest-diameter portion is set to 1 mm or more and less than 30 mm, so that it is possible to reduce a friction force generated by a contact of the threadlike adhesive with the inner wall surface of the smallest-diameter portion while allowing the smallest-diameter portion to guide the threadlike adhesive well and lead the threadlike adhesive out of the tip end opening.

(6) The threadlike adhesive sticking apparatus according to (5), in which
the length of the smallest-diameter portion is 1 mm or more and less than 3 mm.

According to the threadlike adhesive sticking apparatus having the configuration in above (6), the length of the smallest-diameter portion is set to 1 mm or more and less than 3 mm, so that it is possible to reduce a friction force generated by a contact of the threadlike adhesive with the inner wall surface of the smallest-diameter portion while allowing the smallest-diameter portion to guide the threadlike adhesive well and lead the threadlike adhesive out of the tip end opening.

(7) The threadlike adhesive sticking apparatus according to (1), in which
an inner diameter of the internal space is 1.1 times or more to 5.0 times or less the diameter of the smallest-diameter portion.

According to the threadlike adhesive sticking apparatus having the configuration in above (7), the inner diameter of the internal space is set to 1.1 times or more to 5.0 times or less the diameter of the smallest-diameter portion, so that it is possible to reduce a friction force generated by a contact between the inner wall surface of the internal space and the threadlike adhesive, and to smoothly lead the threadlike adhesive out of the tip end opening.

(8) The threadlike adhesive sticking apparatus according to (1), in which
a chamfer is formed on a corner of the smallest-diameter portion on a tip end opening side in a peripheral direction of the nozzle.

According to the threadlike adhesive sticking apparatus having the configuration in above (8), the chamfer is formed on the corner of the smallest-diameter portion on the tip end opening side in the peripheral direction of the nozzle. Such a chamfer is formed on the corner of the smallest-diameter portion on the tip end opening side, so that it is possible to reduce a contact resistance when the threadlike adhesive comes into contact with this corner, and smoothly feed the threadlike adhesive out of the tip end opening.

(9) The threadlike adhesive sticking apparatus according to (1), in which
a chamfer is formed on a corner of the smallest-diameter portion on an internal space side in a peripheral direction of the nozzle.

According to the threadlike adhesive sticking apparatus having the configuration in above (9), the chamfer is formed on the corner of the smallest-diameter portion on the internal space side in the peripheral direction of the nozzle. Such a chamfer is formed on the corner of the smallest-diameter portion on the internal space side, so that it is possible to reduce a contact resistance when the threadlike adhesive comes into contact with this corner, and smoothly feed the threadlike adhesive out of the tip end opening.

(10) A method of sticking a threadlike adhesive including:
sticking the threadlike adhesive to an object using the threadlike adhesive sticking apparatus according to any one of (1) to (9).

According to the method of sticking a threadlike adhesive having the configuration in above (10), even if a surface of the object varies in height or the object is made of a material with low adhesive force, the threadlike adhesive can be stuck well to the object.

(11) The method of sticking a threadlike adhesive according to (10), in which
a pushing force to the threadlike adhesive applied during sticking to the object is set to 0.03 N·sec/mm² or more and 0.6 N·sec/mm² or less, and a friction force applied to the threadlike adhesive is set to 2.0 N or more and 6.0 N or less.

According to the method of sticking a threadlike adhesive having the configuration in above (11), by reducing friction caused by the contact between the nozzle and the threadlike adhesive, the threadlike adhesive can be made to slide, thereby eliminating snagging and the like, so that wear on the surface of the threadlike adhesive can be reduced and variations in tension during sticking can be reduced. Therefore, the threadlike adhesive can be accurately stuck to the object.

(12) The method of sticking a threadlike adhesive according to (11), in which
the pushing force to the threadlike adhesive applied during sticking to the object is set to 0.1 N·sec/mm² or more and 0.6 N·sec/mm² or less, and the friction force applied to the threadlike adhesive is set to 2.0 N or more and 6.0 N or less.

According to the method of sticking a threadlike adhesive having the configuration in above (12), by reducing friction caused by the contact between the nozzle and the threadlike adhesive, the threadlike adhesive can be made to slide, thereby eliminating snagging and the like, so that wear on the surface of the threadlike adhesive can be reduced and variations in tension during sticking can be reduced. Therefore, the threadlike adhesive can be accurately stuck to the object.

### Advantageous Effects of Invention

According to the present invention, a threadlike adhesive sticking apparatus and a method of sticking a threadlike adhesive, by which the threadlike adhesive can be accurately and smoothly stuck to any path, can be provided.

The present invention has been briefly described above. Furthermore, details of the present invention will become clearer by reading embodiments described below with reference to the accompanying drawings.

### BRIEF DESCRIPTION OF DRAWINGS

FIG. 1 is a diagram showing a periphery of a nozzle in a threadlike adhesive sticking apparatus according to the present embodiment.

FIG. 2 is a conceptual diagram showing a mode in which the nozzle of the threadlike adhesive sticking apparatus is moved.

FIG. 3 is a schematic end view along an axial direction of the nozzle.

FIG. 4 is a schematic plan view as viewed from a tip end side of the nozzle.

FIG. 5 is a cross-sectional view of a corner of a smallest-diameter portion of the nozzle on a tip end opening side.

FIG. 6 is a schematic end view along an axial direction of the nozzle of another shape.

FIG. 7 is a cross-sectional view of a corner of the smallest-diameter portion of the nozzle on a cylindrical internal space side.

FIG. 8 is a schematic view showing a threadlike adhesive used in the threadlike adhesive sticking apparatus.

### DESCRIPTION OF EMBODIMENTS

Hereinafter, embodiments of the present invention will be described with reference to the drawings.

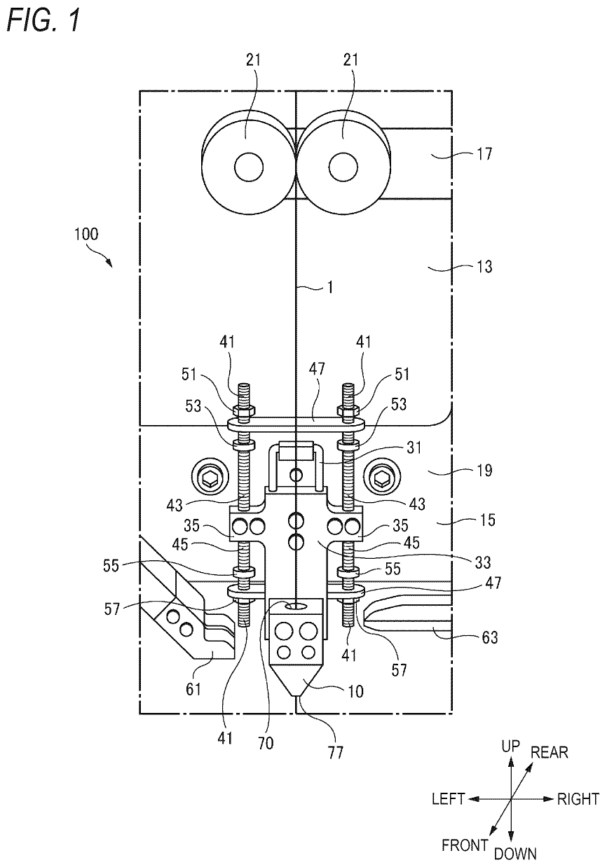

FIG. 1 is a diagram showing a periphery of a nozzle 10 in a threadlike adhesive sticking apparatus 100 according to the present embodiment.

As shown in FIG. 1, the threadlike adhesive sticking apparatus 100 according to the present embodiment includes the nozzle 10. This threadlike adhesive sticking apparatus 100 is an apparatus that leads a threadlike adhesive 1 supplied from a supply mechanism (not shown) out of the nozzle 10 and sticks the threadlike adhesive 1 to an object W to be described later. This threadlike adhesive sticking apparatus 100 is mounted on a horizontal moving unit (moving mechanism) 13, and sticks the threadlike adhesive 1 to the object W while moving relatively to the object W by the moving mechanism.

The nozzle 10 is mounted on an attachment plate 15. The attachment plate 15 is slidably attached in an up-down direction with respect to the horizontal moving unit 13 on a front side of the horizontal moving unit 13. The attachment plate 15 is a thin metal flat plate formed in a substantially U shape, and includes a roller attachment portion 17, a nozzle attachment portion 19 (nozzle displacement unit), and a substantially rectangular connection portion elongated in the up-down direction. The roller attachment portion 17 is a substantially rectangular portion extending in a horizontal direction above the connection portion. The pair of rollers 21 are attached to a front side of the roller attachment portion 17.

The nozzle 10 is configured to be movable in the up-down direction and include an absorption mechanism that absorbs a displacement of the nozzle 10 with respect to a displacement in the up-down direction of a base to which the nozzle 10 is attached. Hereinafter, an example of this configuration will be described, but the configuration related to the displacement of the nozzle 10 is not limited to the following configuration.

The nozzle 10 is fixed to a slider 33 movable in the up-down direction along a slide rail 31. The slider 33 has a substantially rectangular parallelepiped shape, with portions of left and right side surfaces having bulging portions 35 respectively protruding to the left and right sides.

The slide rail 31 is attached to the front of the nozzle attachment portion 19 along the up-down direction. Two bolts 41 and springs 43 and 45 disposed between the two bolts 41 are respectively provided on the left and right sides of the slide rail 31 along the up-down direction. The bolts 41 are inserted through left and right end portions of horizontally long bolt insertion portions 47 in the up-down direction. The bolt insertion portion 47 extends forward from an upper side and a lower side of the nozzle attachment portion 19, separately. Nuts 51 and 53 are respectively disposed on left and right sides above and below the upper bolt insertion portion 47, and are screwed to the bolts 41. Nuts 55 and 57 are respectively disposed on the left and right sides above and below the lower bolt insertion portion 47, and are screwed to the bolts 41.

The spring 43 is disposed between the nut 53 and an upper portion of the bulging portion 35, and the spring 45 is disposed between a lower portion of the bulging portion 35 and the nut 55. A lower end portion of the upper bolt 41 is inserted into an upper side of the spring 43, and a lower side of the spring 43 is fixed to the bulging portion 35, thereby preventing the spring 43 from being detached. An upper side of the spring 45 is fixed to the bulging portion 35, and an upper end portion of the lower bolt 41 is inserted into a lower side of the spring 45, thereby preventing the spring 45 from being detached.

The nozzle 10 is fixed to the slider 33, and is displaced in accordance with a displacement of the slider 33 in the up-down direction. Specifically, as a lifting body of the horizontal moving unit 13 is raised and lowered (displaced), the nozzle attachment portion 19 fixed to the lifting body is raised and lowered (displaced). Here, the slider 33 slidably attached to the nozzle attachment portion 19 does not slide, and a position of the slider 33 on the nozzle attachment portion 19 does not change in a state where the springs 43 and 45 are attached up and down and no load is applied to the nozzle 10. On the other hand, when the nozzle 10 is pressed against the object W via the threadlike adhesive 1, an elastic force in a direction opposite to a pressing direction is generated in the springs 43 and 45. That is, the springs 43 and 45 absorb the displacement of the nozzle 10 with respect to the displacement of the nozzle attachment portion 19. Accordingly, it is possible to control a force (pushing force) with which the nozzle 10 presses the threadlike adhesive 1 against the object W, and to prevent a pressing force from excessively increasing or rapidly increasing. Therefore, it is possible to prevent a large deformation of the threadlike adhesive 1, that is, a problem such as sticking out of the adhesive (lowering of adhesion width accuracy) or unevenness of the height of the threadlike adhesive 1 due to an excessively strong pushing force, and to appropriately express an adhesive force of the threadlike adhesive 1. In addition, it is possible to protect the apparatus by preventing an excessive load from being applied to the nozzle 10.

In this way, the springs 43 and 45 function as an absorption mechanism that absorbs the displacement of the nozzle 10 with respect to the displacement of the nozzle attachment portion 19, and gently change the pushing force. Therefore, even in a case where a height of an adhesive surface of the object W changes or in a case where the adhesive surface of the object W is not smooth and has unevenness, the above-described problem can be prevented. In addition, even in a location where the threadlike adhesive 1 overlaps in a sticking path, the threadlike adhesive 1 can be smoothly stuck over the stuck threadlike adhesive 1 by the function of the springs 43 and 45. Instead of the springs 43 and 45, an oil damper or an air cylinder may be attached between the nozzle attachment portion 19 and the nozzle 10 to function as an absorption mechanism. The absorption mechanism is merely one example. The absorption mechanism may have another configuration such that the nozzle 10 is movable in the up-down direction, and absorbs the displacement of the nozzle 10 with respect to the displacement in the up-down direction of the base to which the nozzle 10 is attached.

An air chuck 61 and an air scissor 63 are attached to a front surface side of the nozzle attachment portion 19. The air chuck 61 and the air scissors 63 are examples of a cutting mechanism. The air chuck 61 is an example of a gripping portion, and the air scissors 63 is an example of a cutting portion. When the sticking of the threadlike adhesive 1 is completed, the air chuck 61 and the air scissor 63 are separately moved from a normal position (position in FIG. 1) to an operation position by a driving unit. The air chuck 61 is moved obliquely from the normal position to a lower right position, and chucks the threadlike adhesive 1 immediately below the nozzle 10. The air scissor 63 is moved downward from the normal position and then moved leftward to cut the chucked threadlike adhesive 1 immediately below the air chuck 61. Since the air chuck 61 and the air scissor 63 are attached to the lifting body of the horizontal moving unit 13 via the attachment plate 15 similarly to the nozzle 10, the air chuck 61 and the air scissor 63 can be moved together with the nozzle 10 while maintaining a positional relationship with respect to the nozzle 10. The air chuck 61 and the air scissor 63 are not limited in a shape, a driving method, and the like as long as they can hold and cut the threadlike adhesive 1 at predetermined positions. The driving unit for the cutting mechanism includes an air cylinder, a motor, and the like. The cutting portion may be, for example, one that clamps and cuts the threadlike adhesive 1 with a pair of blades (double-edged blade), such as a scissor or a nipper, a cutter that pushes and cuts the threadlike adhesive 1 with one blade (single-edged blade), a heat cutter that burns and cuts the threadlike adhesive 1 with heat, or an ultrasonic cutter that cuts the threadlike adhesive 1 with ultrasonic vibration. In addition, when the cutting mechanism is a cutting portion with a single-edged blade, the threadlike adhesive 1 can be cut by pressing a single-edged blade against an object without providing a gripping portion.

Using the threadlike adhesive sticking apparatus 100 configured as described above, an operator who sticks the threadlike adhesive 1 to the object W first places the object W on a stage. At the start of the operation, the threadlike adhesive 1 supplied from the supply mechanism to the nozzle 10 is led out to the outside from a tip end 77 of the nozzle 10, and the operator presses the tip end 77 into a predetermined position on the object W. A relative position of the nozzle 10 with respect to the object W is subjected to movement control by a control apparatus (not shown) in accordance with a program set in advance. The program includes instructions such as a movement path, a movement speed, and a movement amount (a magnitude of a pushing force) in the up-down direction of the nozzle 10 in a horizontal plane. When the movement of the nozzle 10 is started according to the program, the threadlike adhesive 1 is fed out of the supply mechanism by an adhesive force of the threadlike adhesive 1 with respect to the object W. The nozzle 10 presses an adhesive surface of the fed out threadlike adhesive 1, and the threadlike adhesive 1 is pressed against and stuck (pressure-bonded) to the object W along a predetermined path while the nozzle 10 slides on the adhesive surface. After the sticking is completed, the threadlike adhesive 1 is cut at a predetermined position by the air chuck 61 and the air scissor 63.

When sticking the threadlike adhesive 1 to the object W along a predetermined path, the threadlike adhesive sticking apparatus 100 may press the nozzle 10 more strongly at a desired location, that is, increase a downward displacement amount of the nozzle attachment portion 19 in the up-down direction (approach the object W). Even when the nozzle attachment portion 19 is momentarily lowered, it is possible to appropriately increase the force with which the nozzle 10 presses the threadlike adhesive 1 and to increase the adhesive force of the threadlike adhesive 1 at a desired location since the nozzle 10 is gently lowered by the springs (absorption mechanism) 43 and 45. In addition, the threadlike adhesive sticking apparatus 100 may stop the movement in the horizontal plane (fix the position of the nozzle 10 with respect to the object W) while pressing the nozzle 10 for several seconds at the desired location. By not moving a plane position of the nozzle 10 while pressing the nozzle 10, it is possible to increase a pressing time of the threadlike adhesive 1 and to increase the adhesive force of the threadlike adhesive 1 at a desired location. In a case where the threadlike adhesive 1 is stuck while being fed out of the supply mechanism, the threadlike adhesive 1 is easily peeled off at a start point (initial stage of sticking) of a predetermined path, a start point or an end point of a curve included in the predetermined path, a vertex of a corner included in the predetermined path, or the like. Therefore, at these locations, by lowering the nozzle 10 or stopping the nozzle 10 for several seconds while pressing the nozzle 10, it is possible to increase the adhesive force of the threadlike adhesive 1 and prevent peeling.

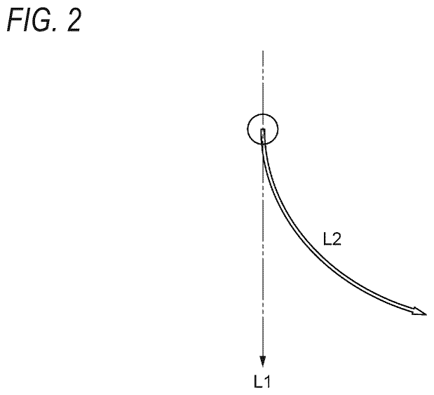

FIG. 2 is a conceptual diagram showing a mode in which the nozzle 10 is moved on the object W. Not only when the nozzle 10 goes straight as shown by an arrow L1, but also when a curve shown by an arrow L2 is extremely bent (bent at a steep angle), the threadlike adhesive sticking apparatus 100 can stick the threadlike adhesive 1 with high accuracy.

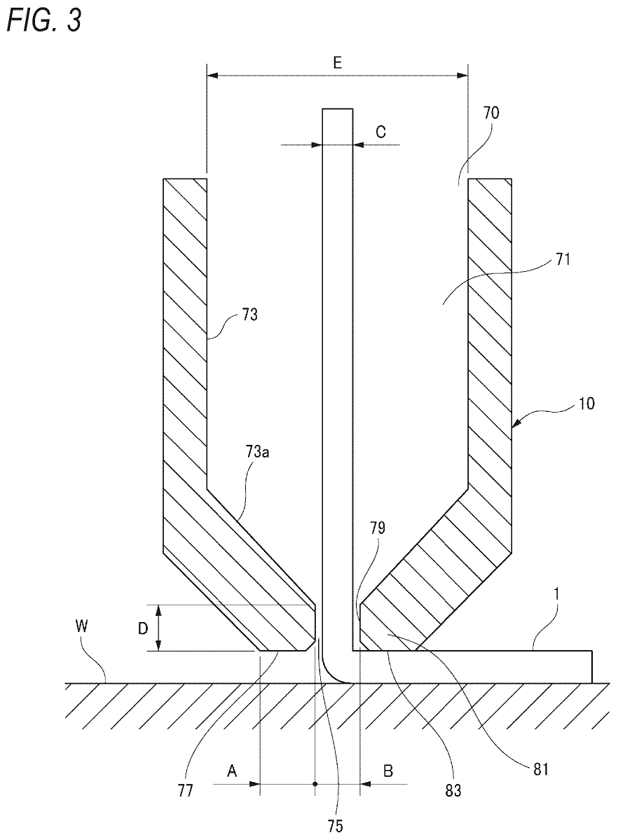

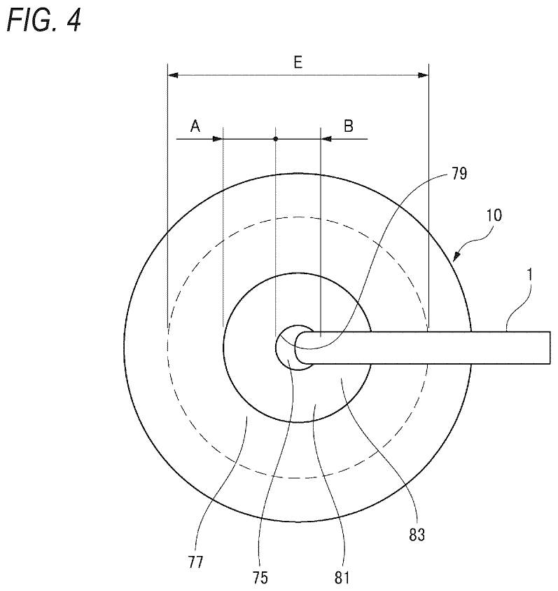

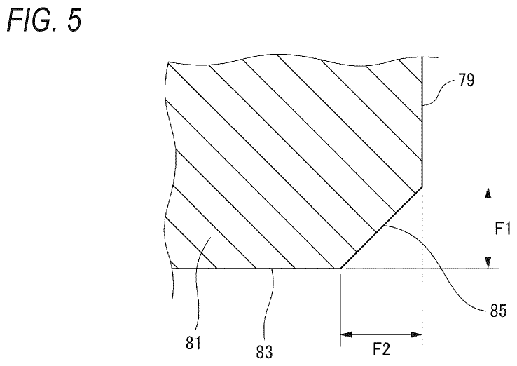

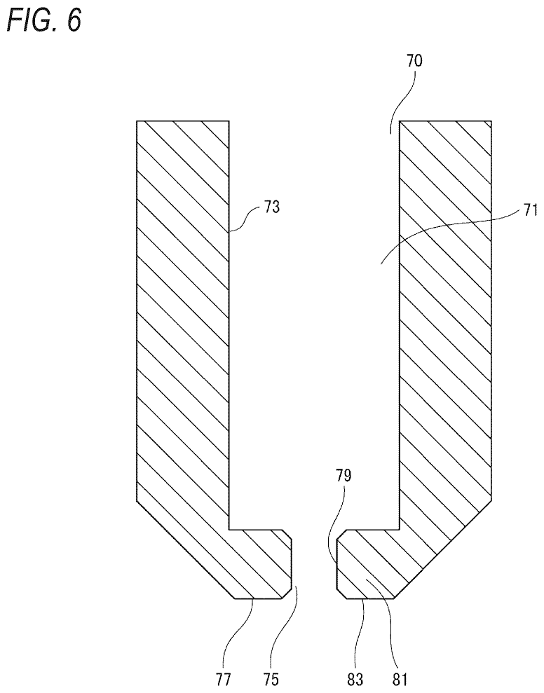

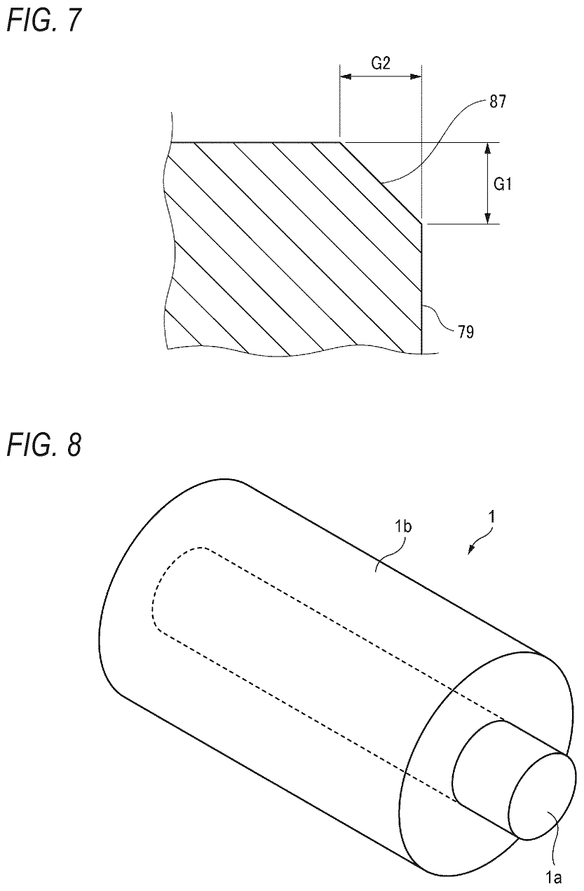

FIG. 3 is a schematic end view along an axial direction of the nozzle 10. FIG. 4 is a schematic plan view as viewed from a tip end side of the nozzle 10. FIG. 5 is a cross-sectional view of a corner of a smallest-diameter portion 79 of the nozzle 10 on a tip end opening 75 side. FIG. 6 is a schematic end view along an axial direction of the nozzle 10 of another shape. FIG. 7 is a cross-sectional view of a corner of the smallest-diameter portion 79 of the nozzle 10 on a cylindrical internal space 71 side.

As shown in FIGS. 3 and 4, the nozzle 10 has an inner wall surface 73 that defines a cylindrical internal space (internal space) 71 extending in the up-down direction, and the tip end 77 having a tip end opening 75 at a lower end portion, which is one end of the inner wall surface 73, the tip end opening 75 allowing the cylindrical internal space 71 to communicate with the outside. The nozzle 10 has the smallest-diameter portion 79 at the tip end 77 of the nozzle 10, and an opening at the end portion of this smallest-diameter portion 79 is the tip end opening 75. The inner wall surface 73 has a tapered portion 73a formed such that the lower end portion is funnel-shaped with a gradually expanding diameter from the smallest-diameter portion 79 side toward the upper side.

In the nozzle 10, the threadlike adhesive 1 introduced from an insertion side opening 70 on the upper end side is passed into the cylindrical internal space 71. The threadlike adhesive 1 passes through the cylindrical internal space 71, passes through the smallest-diameter portion 79, and is led out from the tip end opening 75 to the outside. The nozzle 10 presses the threadlike adhesive 1 led out of the tip end opening 75 against the object W. More specifically, the entire circumference or any of a plurality of locations of a peripheral portion 81 surrounding the tip end opening 75 of the nozzle 10 function as a pressing unit 83 that presses the threadlike adhesive 1 against the object W. Therefore, it is possible to stick the threadlike adhesive 1 while moving the nozzle 10 in a plurality of optional directions without using a roller or the like as the pressing unit. Therefore, in a case where the threadlike adhesive 1 is pressed by the roller, it is possible to prevent a problem that the adhesion accuracy is poor due to the movement of the threadlike adhesive 1 within a roller width, and the threadlike adhesive 1 is detached from the roller depending on an adhesion path, and thus it is possible to accurately stick the threadlike adhesive 1.

In the nozzle 10, a value (A×0.6B) obtained by multiplying a thickness A of the surface functioning as the pressing unit 83 of the peripheral portion 81 and a numerical value 0.6 times a diameter B of the smallest-diameter portion 79 of the tip end opening 75 is 0.3 mm² or more and 3.0 mm² or less.

Incidentally, if the pushing force of the threadlike adhesive 1 by the surface functioning as the pressing unit 83 of the peripheral portion 81 of the nozzle 10 is too small, the threadlike adhesive 1 repulses and becomes easily peeled off from the object W, and if the pushing force is too large, the friction force with the threadlike adhesive 1 is large, sticking to the object W becomes difficult.

Therefore, the value obtained by multiplying the thickness A of the surface functioning as the pressing unit 83 of the peripheral portion 81 of the nozzle 10 and the numerical value 0.6 times the diameter B of the smallest-diameter portion 79 of the tip end opening 75 is 0.3 mm² or more and 3.0 mm² or less. Accordingly, an initial adhesive force of the threadlike adhesive 1 to the object W is easily obtained, and the threadlike adhesive 1 can be attached to the object W without peeling even with a small pushing force. Even if the pushing force is large, a pressure on the threadlike adhesive 1 is reduced, and a friction force with the threadlike adhesive 1 can be reduced. Therefore, even if a surface of the object W varies in height or the object W is made of a material with low adhesive force, the threadlike adhesive 1 can be stuck well.

In the nozzle 10, a value (A×1.5C) obtained by multiplying the thickness A of the surface functioning as the pressing unit 83 of the peripheral portion 81 and a numerical value 1.5 times an average outer diameter C of the threadlike adhesive 1 is 0.3 mm² or more and 3.0 mm² or less.

Accordingly, the value obtained by multiplying the thickness A of the surface functioning as the pressing unit 83 of the peripheral portion 81 and the numerical value 1.5 times the average outer diameter C of the threadlike adhesive 1 is set to 0.3 mm² or more and 3.0 mm² or less, so that a pushing area of the threadlike adhesive 1 onto the object W is within an appropriate range. Accordingly, the initial adhesive force of the threadlike adhesive 1 to the object W can be more easily obtained, and the threadlike adhesive 1 can be stuck well to the object W, particularly in the initial stage of sticking.

Furthermore, in the nozzle 10, the thickness A of the surface functioning as the pressing unit 83 of the peripheral portion 81 is set to 0.5 mm or more and 10.0 mm or less. Accordingly, it is possible to reduce floating of the threadlike adhesive 1 due to repulsion when the nozzle 10 is pushed while obtaining a good initial adhesive force of the threadlike adhesive 1 to the object W, thereby enabling the threadlike adhesive 1 to be well stuck to the object W.

In the nozzle 10, a length D of the smallest-diameter portion 79 is 1 mm or more and less than 30 mm. In a case of a resin nozzle, the length D of the smallest-diameter portion 79 is set to 1 mm or more and less than 30 mm, so that it is possible to reduce a friction force generated by a contact of the threadlike adhesive 1 with the inner wall surface of the smallest-diameter portion 79 while allowing the smallest-diameter portion 79 to guide the threadlike adhesive 1 well and lead the threadlike adhesive 1 out of the tip end opening 75.

When a metal nozzle is subjected to a slippage improvement treatment to be described below, the length D of the smallest-diameter portion 79 is set to 1 mm or more and less than 3 mm, so that it is possible to reduce a friction force generated by a contact of the threadlike adhesive 1 with the inner wall surface of the smallest-diameter portion 79 while allowing the smallest-diameter portion 79 to guide the threadlike adhesive 1 well and lead the threadlike adhesive 1 out of the tip end opening 75. Not only the friction force but also hardness of a base material are involved in the leading-out of the threadlike adhesive 1 from the nozzle.

Furthermore, in the nozzle 10, an inner diameter E of the cylindrical internal space 71 is 1.1 times or more to 5.0 times or less the diameter B of the smallest-diameter portion 79. Accordingly, the inner diameter E of the cylindrical internal space 71 is set to 1.1 times or more to 5.0 times or less the diameter B of the smallest-diameter portion 79, so that it is possible to reduce a friction force generated by a contact between the inner wall surface 73 of the cylindrical internal space 71 and the threadlike adhesive 1, and to smoothly lead the threadlike adhesive 1 out of the tip end opening 75.

In the nozzle 10, a chamfer 85 is formed on a corner of the smallest-diameter portion 79 on the tip end opening 75 side in a peripheral direction of the nozzle 10. As shown in FIG. 5, the chamfer 85 is preferably such that a dimension F1 of the nozzle 10 in the axial direction and a dimension F2 of the nozzle 10 in a radial direction are set to 0.05 mm or more and 0.3 mm or less, respectively, when viewed in a cross section of the nozzle 10 in the axial direction. Such a chamfer 85 is formed on the corner of the smallest-diameter portion 79 on the tip end opening 75 side, so that it is possible to reduce a contact resistance when the threadlike adhesive 1 comes into contact with this corner, and smoothly feed the threadlike adhesive 1 out of the tip end opening 75.

As shown in FIG. 6, the inner wall surface 73 of the nozzle 10 may not have the tapered portion 73a. In this case, it is preferable to form a chamfer 87 on a corner of the smallest-diameter portion 79 on the cylindrical internal space 71 side in the peripheral direction of the nozzle 10. As shown in FIG. 7, the chamfer 87 is preferably such that a dimension G1 of the nozzle 10 in the axial direction and a dimension G2 of the nozzle 10 in the radial direction are set to 0.05 mm or more and 0.3 mm or less, respectively, when viewed in the cross section of the nozzle in the axial direction. Such a chamfer 87 is formed on the corner of the smallest-diameter portion 79 on the cylindrical internal space 71 side, so that it is possible to reduce a contact resistance when the threadlike adhesive 1 comes into contact with this corner, and smoothly feed the threadlike adhesive 1 out of the tip end opening 75.

The chamfers 85 and 87 may be C-chamfers in which the corners are each formed into a flat surface, or R-chamfers in which the corners are each formed into a curved surface in an arc shape.

The above nozzle 10 is preferably formed from a resin material having poor adhesiveness, such as a fluorine-based resin such as polytetrafluoroethylene (PTFE), perfluoroalkoxy alkane (PFA), ethylene-tetrafluoroethylene copolymer (ETFE), polyvinylidene difluoride (PVDF), and polychlorotrifluoroethylene (PCTFE), or an olefin-based resin such as polypropylene (PP) and ultra-high molecular weight polyethylene (UHMW-PE).

The nozzle 10 may be made of a metal material such as iron. At least a location of the nozzle 10 that comes into contact with the threadlike adhesive 1 may be subjected to various slippage improvement treatments. Examples of this slippage improvement treatment include polyether ether ketone (PEEK) coating, fluorine composite electroless nickel plating (in which fine particles of fluororesin are dispersed and co-deposited in an electroless nickel plating film), Biceram (fluororesin coating containing micronized ceramic particles), fiber reinforced plastics (FRP) lining, or ultrahigh molecular polyester (PE) lining. Accordingly, the threadlike adhesive 1 led out of the nozzle 10 can be smoothly stuck to the object W.

Furthermore, a shape of the tip end opening 75 of the nozzle 10 is not limited to a circle, and may be a polygon having five or more sides. When the shape of the tip end opening 75 of the nozzle 10 is a circle or a polygon having five or more sides, a sticking direction can be easily changed.

When the threadlike adhesive 1 is stuck to the object W by using the threadlike adhesive sticking apparatus 100 having the above configuration, the pushing force to the threadlike adhesive 1 applied during sticking to the object W is set to 0.03 N·sec/mm² or more and 0.6 N·sec/mm² or less, and the friction force applied to the threadlike adhesive 1 is set to 2.0 N or more and 6.0 N or less. In this way, in the case of the resin nozzle, by reducing friction caused by the contact between the nozzle 10 and the threadlike adhesive 1, the threadlike adhesive 1 can be made to slide, thereby eliminating snagging and the like, so that wear on the surface of the threadlike adhesive 1 can be reduced and variations in tension during sticking can be reduced. Therefore, the threadlike adhesive 1 can be accurately stuck to the object W. The friction force between the nozzle 10 and the threadlike adhesive 1 can be made smaller than the adhesive force between the object W and the threadlike adhesive 1, and the threadlike adhesive 1 led out of the nozzle 10 can be smoothly stuck to the object W.

In the case of the metal nozzle, the pushing force is set to 0.1 N·sec/mm² or more and 0.6 N·sec/mm² or less, and the friction force applied to the threadlike adhesive 1 is set to 2.0 N or more and 6.0 N or less, so that the threadlike adhesive 1 led out of the nozzle 10 can be smoothly stuck to the object W in the same manner as described above. Since the resin-based nozzle can perform sticking even with a small pushing force, a sticking speed can be further increased.

As described above, by using the resin-based nozzle, such as a PTFE nozzle, as the nozzle 10, friction caused by a contact between the nozzle and the threadlike adhesive can be further reduced, and the length D of the smallest-diameter portion 79 can be increased. The length D of the smallest-diameter portion 79 is, for example, 1 mm or more and less than 30 mm. Accordingly, left-right fluctuations of the threadlike adhesive can be reduced, and thus even if the adhesive is stuck at a higher speed, there is less deviation in a trajectory, and stable sticking can be achieved. In addition, by using a resin-based nozzle, such as a PTFE nozzle, as the nozzle 10, an increase in the friction force is small, and thus even if the pushing force is small, a start point sticking property is good, and the threadlike adhesive can be stuck to the object with high accuracy and at high speed. The pushing force to the threadlike adhesive 1 applied during sticking to the object is, for example, set to 0.03 N·sec/mm² or more and 0.6 N·sec/mm² or less, and the friction force applied to the threadlike adhesive is set to 2.0 N or more and 6.0 N or less.

FIG. 8 shows a schematic view of the threadlike adhesive 1 used in the threadlike adhesive sticking apparatus 100 according to the above embodiment.

As shown in FIG. 8, the threadlike adhesive 1 is an adhesive body constituted by a linear core material 1a and an adhesive layer 1b that covers a surface of the core material 1a in a longitudinal direction, and has a long linear shape. The linear shape mentioned here is a concept including not only a straight line shape, a curved line shape, a polygonal line shape, and the like, but also a state in which a material can be bent in various directions and angles like a filament (that is, a threadlike shape). In addition, the adhesive layer 1b in the present specification also includes a linear adhesive layer.

Although a cross-sectional shape of the threadlike adhesive 1 in the present configuration example is a circular shape, the present embodiment is not limited thereto, and the cross-sectional shape may be an elliptical shape, a rectangular shape such as a quadrangular shape, or the like, in addition to the circular shape.

The adhesive layer 1b contains an adhesive formed of an adhesive composition. The adhesive is not particularly limited as long as the adhesive satisfies the above gel fraction and an amount of a change in the gel fraction, and a known adhesive can be used. Examples of the adhesive include an acrylic-based adhesive, a rubber-based adhesive, a vinyl alkyl ether-based adhesive, a silicone-based adhesive, a polyester-based adhesive, a polyamide-based adhesive, a urethane-based adhesive, a fluorine-based adhesive, and an epoxy-based adhesive. Among these adhesives, an acrylic-based adhesive, a urethane-based adhesive, a silicone-based adhesive, a rubber-based adhesive, or a polyester-based adhesive is preferable, and an acrylic adhesive is particularly preferable from a viewpoint of adhesiveness. The adhesive may be used alone or in combination of two or more kinds thereof. The adhesive in the present embodiment is preferably a pressure-sensitive adhesive that has adhesiveness at a room temperature and can be stuck to a surface of an adherend by a pressure generated when a surface of the adhesive and the surface of the adherend are brought into contact with each other. When the adhesive is a pressure-sensitive adhesive, the adhesive does not need to be heated and can be applied to an adherend that is sensitive to heat.

As the adhesive, either a solvent-type adhesive or a water-dispersible type adhesive can be used. The adhesive is preferably an adhesive obtained by performing crosslinking by drying (solvent volatilization) an adhesive composition and rapidly completing the crosslinking after drying. This is because new crosslinking does not increase after surfaces of adhesive layers 1b come into contact with each other. Here, the adhesive is preferably a water-dispersible type adhesive, and more preferably a water-dispersible type acrylic adhesive because of high-speedily coating, being friendly to the environment, and a small influence on a base material or the core material 1a (swelling or dissolution).

In the threadlike adhesive 1 having the core material 1a, the adhesive layer 1b may cover the entire surface of the core material 1a (a surface in a longitudinal direction), or may cover only at least a part of the surface of the core material 1a. Although the adhesive layer 1b is typically formed to be continuous, the adhesive layer is not limited to such a form, and may be formed in a regular pattern such as a dot pattern or a stripe pattern, or a random pattern. An end surface of the core material 1a may or may not be covered by the adhesive layer 1b. For example, when the threadlike adhesive 1 is cut during a producing process or during use, the end surface of the core material 1a may not be covered by the adhesive layer 1b.

As the core material 1a used in the threadlike adhesive 1, for example, a resin, rubber, foam, an inorganic fiber, and a composite thereof can be used. Examples of the resin include a polyolefin such as polyethylene (PE), polypropylene (PP), an ethylene-propylene copolymer, and an ethylene-vinyl acetate copolymer; a polyester such as polyethylene terephthalate (PET); a vinyl chloride resin; a vinyl acetate resin; a polyimide resin; a polyamide resin; and a fluorine-based resin. Examples of the rubber include natural rubber, and synthetic rubber such as urethane rubber. Examples of the foam include a foamed polyurethane and a foamed polychloroprene rubber. Examples of the fiber include a glass fiber, a carbon fiber, a metal fiber, a chemical fiber (a regenerated fiber, a semi-synthetic fiber, a synthetic fiber, and the like), and a natural fiber (a plant fiber, an animal fiber, and the like). A cross-sectional shape of the core material 1a is not particularly limited, and is usually a cross-sectional shape corresponding to a cross-sectional shape of the threadlike adhesive 1.

Examples of a material of the threadlike core material 1a that can be used in the threadlike adhesive 1 include various polymer materials such as rayon, cupra, acetate, promix, nylon, aramid, vinylon, vinylidene, polyvinyl chloride, polyester, acryl, polyethylene, polypropylene, polyurethane, polychlal, and polylactic acid; glasses, carbon fibers, various rubbers such as natural rubber and synthetic rubber such as polyurethane; natural materials such as cotton and wool; and metal. As the form of the threadlike core material 1a, for example, monofilaments, multifilaments, span yarns, finished yarns generally referred to as textured yarn, bulky yarn, and stretched yarn that are subjected to crimping or bulking, or combined yarns obtained by, for example, twisting those can be used. The cross-sectional shape is not limited to only a circle, and can be a rectangular shape such as a square shape, a star shape, an elliptical shape, a hollow shape, and the like.

The core material 1a may contain various additives such as a filler (inorganic filler, organic filler, or the like), an age resister, an antioxidant, a UV absorber, an antistatic agent, a lubricant, a plasticizer, and a coloring agent (pigments, dyes, or the like) as necessary. A known or common surface treatment such as a corona discharge treatment, a plasma treatment, or application of an undercoat agent may be performed on the surface of the core material 1a.

A size of a cross-section of the core material 1a is not particularly limited and may be appropriately selected depending on a purpose. For example, when the cross-sectional shape of the core material is a circular shape, a diameter of the cross-sectional shape of the core material is preferably 1 μm to 2000 μm, and more preferably 10 μm to 1000 μm from the viewpoint of handleability (flexibility, difficulty in cutting).

A thickness of the adhesive layer 1b is not particularly limited, and is, for example, preferably 1 μm or more, and more preferably 3 μm or more from the viewpoint of adhesiveness. The thickness of the adhesive layer 1b is, for example, preferably 200 μm or less, and more preferably 150 μm or less from the viewpoint of thickness unevenness and drying properties. Furthermore, the thickness can be increased according to an application by stacking layers.

In particular, the threadlike adhesive 1 is preferably a pressure-sensitive adhesive body in which the adhesive forming the adhesive layer 1b has adhesiveness at room temperature and that can be stuck to a surface of an adherend by a pressure generated when a surface of the adhesive and the surface of the adherend are brought into contact with each other. When the adhesive body is a pressure-sensitive adhesive body, the adhesive body does not need to be heated and can be applied to an adherend that is sensitive to heat.

As described above, the shape of the threadlike adhesive 1 is not particularly limited. The larger a ratio (major axis/minor axis) of a length of the major axis (the longest axis that passes through the center of gravity of the cross-sectional shape) to a length of the minor axis (the shortest axis that passes through the center of gravity of the cross-sectional shape) of the cross-sectional shape of the threadlike adhesive 1 is, the flatter the shape of the threadlike adhesive 1 is. On the other hand, as the ratio becomes smaller, the cross-sectional shape of the threadlike adhesive 1 comes close to a circular shape, and when the cross-sectional shape of the threadlike adhesive 1 is a circular shape, the ratio has a minimum value of 1. When the ratio has a minimum value of 1, the cross-sectional shape of the threadlike adhesive 1 also includes a special shape such as a triangle and a star shape.

The threadlike adhesive 1 may have a release liner. When the threadlike adhesive 1 has the release liner, the release liner may be peeled off from the adhesive layer 1b before the threadlike adhesive 1 reaches the nozzle 10 or the like, the release liner may be peeled off after the sticking, and in both cases, the threadlike adhesive 1 can be stuck to the object W. Since the threadlike adhesive 1 has the release liner, a self-adhesive force of the threadlike adhesive 1 can be reduced, and thus the threadlike adhesive 1 can be pressed against the object W in a state in which the tension of the threadlike adhesive 1 is reduced. Therefore, it is possible to prevent a problem that the threadlike adhesive 1 pressed against the object W is peeled off, cut, re-stuck, and entangled by the tension, and to smoothly stick the threadlike adhesive 1.

Embodiments and usage methods of the threadlike adhesive 1 are roughly classified into the following four patterns. Here, a non-adhesive layer is a layer that covers a surface (a surface in the longitudinal direction) of the threadlike adhesive 1, and the non-adhesive layer includes, for example, a layer that covers the threadlike adhesive 1 in an initial state before stretching and is cut out by stretching the threadlike adhesive 1 to exhibit adhesiveness of the threadlike adhesive 1. However, a type, a material, and the like of the non-adhesive layer are not particularly limited.
1) An adhesive body without a non-adhesive layer is pressed (pressure-bonded) and stuck as it is
2) An adhesive body without a non-adhesive layer+a release liner (the release liner is peeled off before or after pressure-bonding)
3) An adhesive body covered by a non-adhesive layer
4) An adhesive body covered by a non-adhesive layer+a release liner (the release liner is peeled off before or after pressure-bonding)

Regarding the above 2) or 4), as an example in which the release liner is peeled off after the pressure-bonding, the release liner is peeled off after the adhesive body is stuck to a first object and before being stuck to a second object.

Further, the threadlike adhesive 1 of the present embodiment has flexibility and has a threadlike shape that can be bent in various directions and angles like a filament. The threadlike adhesive 1 having flexibility, in particular, the threadlike adhesive 1 having a threadlike shape has an advantage in that the adhesive body can be easily applied to complicated shapes such as a curved line, a curved surface, and an uneven shape in addition to the effects described above.

For example, when an adhesive tape is stuck to an adherend having a part with a complicated shape such as a curved line, a curved surface, or an uneven shape, a wrinkle or overlapping may occur in the adhesive tape in such a part, and it is difficult to finely stick the adhesive tape while inhibiting a protrusion. The part where the wrinkle or overlapping occurs may cause a decrease in the adhesive force. In order to stick the adhesive tape while preventing the occurrence of the wrinkle or overlapping, it is conceivable to stick the adhesive tape while finely cutting the adhesive tape, but workability significantly deteriorates. On the other hand, the threadlike adhesive 1 having flexibility, in particular, the threadlike adhesive 1 having a threadlike shape can be firmly stuck without causing the wrinkle or overlapping even when being stuck to a part having a complicated shape such as a curved line, a curved surface, and an uneven shape. Further, since such a threadlike adhesive 1 can be stuck to a part to be stuck at one time, that is, in one step, the adhesive body is excellent in workability and can be applied to an automation line.

Specific examples of an application of the threadlike adhesive 1 include an application to fix cables such as electric wires or optical fibers, optical fiber sensors such as LED fiber light and Fiber Bragg Gratings (FBG), various wire members (linear members) such as a yarn, a string, and a wire, and a narrow member, in a desired form. For example, even in a case where a wire member or a narrow member is fixed to another member in a complicated shape, the threadlike adhesive 1 can be firmly fixed with excellent workability while inhibiting protrusion, wrinkles, and overlapping in accordance with the complicated shape of the wire member or the narrow member. In a case where the wire member or the narrow member is fixed to another member, the threadlike adhesive 1 is stuck in advance in accordance with a form in which the wire member or the narrow member is to be fixed on a surface of the another member, and then, the wire member or the narrow member can be stuck and fixed in accordance with the threadlike adhesive 1 stuck to the surface of another member. Alternatively, the threadlike adhesive 1 is stuck to the wire member or the narrow member, and then, the wire member or the narrow member may be fixed to another member in a desired form.

The threadlike adhesive 1 can also be suitably used for temporary fixing (temporary tacking) of an article for temporarily fixing (temporarily tacking) one article to a surface of another article. More specifically, the threadlike adhesive 1 can be particularly suitably used for temporary fixing (temporary tacking) in producing, for example, fiber products and leather products such as clothes, shoes, bags, and hats. However, the application is not limited to this example, and the threadlike adhesive is suitably used for various applications in which temporary fixing (temporary tacking) is desired.

For example, when one article is fixed to a surface of another article, the one article is temporarily fixed and positioned on the surface of the another article in advance by using the threadlike adhesive 1, and then both articles are fixed (finally fixed) by a fixing method such as thermocompression bonding and sewing. In this case, the threadlike adhesive 1 easily and temporarily fixes the two articles with avoiding a fixing unit provided between the two articles. For example, in a case where a fiber product or a leather product is sewn, if temporary fixing is performed by using the threadlike adhesive 1, the temporary fixing can be easily performed while avoiding a part to be sewed, and the adhesive can be easily prevented from adhering to a needle.

As described above, even when shapes of the two articles are complicated shapes such as a curved line, a curved surface, and an uneven shape, the threadlike adhesive 1 can be well stuck while inhibiting a protrusion, a wrinkle, and overlapping, and can be stuck in one step, and the workability is improved.

Even in a case of a member that is easily deformed, such as fabric, cloth, and leather that form a fiber product or a leather product, temporary fixing can be performed by using the threadlike adhesive 1, so that deformation of the member due to the tension can be inhibited or prevented, and a design after fixing (final fixing) is improved.

Further, after two articles are fixed (finally fixed) by the threadlike adhesive 1, the threadlike adhesive 1 can be pulled out and removed from the two articles that are fixed (finally fixed) if necessary. In this case, the adhesive can be prevented from squeezing out, and deterioration of a design due to aging discoloration of the remaining adhesive can be satisfactorily prevented.

Furthermore, the threadlike adhesive 1 can be twisted with a yarn made of other material to form a composite yarn or can be woven with a yarn or cloth (including nonwoven fabric and sheet) made of other material, thereby function combination can be attempted.

Further, the threadlike adhesive 1 can be used as a dam material for preventing squeezing out of a glue or an adhesive when a glue or an adhesive is applied to an adhesion object (adherend). The dam material can be used, for example, to prevent squeezing out of a sealing resin used for bonding an optical panel. In the case where the threadlike adhesive 1 is used as a dam material, the threadlike adhesive 1 may be peeled off or remain after the glue or the adhesive is cured.

Noted that the present invention is not limited to the embodiment described above, and modifications, improvements, and the like can be made as appropriate. Materials, shapes, sizes, numbers, arrangement locations, and the like of components in the embodiments described above are set as desired and are not limited as long as the present invention can be achieved. For example, the threadlike adhesive sticking apparatus may include the nozzle 10 and a gripping portion that can be held by an operator, and the operator may grip the gripping portion and operate the adhesive sticking apparatus to stick the threadlike adhesive 1 to an object. If the gripping portion has, for example, a long and thin shaft shape, the operator can use the threadlike adhesive sticking apparatus in the same way as operating a writing implement such as a pen, can operate the threadlike adhesive sticking apparatus as desired even in a narrow space with many obstacles, and can efficiently perform various tasks.

In the above embodiment, an example in which the threadlike adhesive sticking apparatus 100 including the nozzle 10 is mounted on the horizontal moving unit 13 has been shown, but the moving mechanism is not limited to the horizontal moving unit 13. A multi-axis articulated robot with, for example, 4 axes, 6 axes, and 12 axes, is used as the moving mechanism, and the threadlike adhesive sticking apparatus 100 can be used by being attached to a tip end of an arm of the articulated robot as a head. Furthermore, a three-axis stage which is provided in a three-dimensional embroidery machine, a 3D printer, and the like, and allows the stage and a head to move relatively in three dimensions is used as the moving mechanism, and the threadlike adhesive sticking apparatus 100 can be used by being attached as the head of this three-axis stage. Even when the articulated robot or the three-axis stage is used as the moving mechanism, the threadlike adhesive sticking apparatus 100 according to the present embodiment can press the threadlike adhesive 1 against the object W with an appropriate pressing force and stick the threadlike adhesive 1 to the object W well. Therefore, even for a three-dimensional object W, the threadlike adhesive 1 can be pressed against a surface of the object W with an appropriate pressing force and stuck well.

Here, features of the threadlike adhesive sticking apparatus and the method of sticking a threadlike adhesive according to the embodiments of the present invention described above will be briefly summarized and listed in the following [1] to [12].

[1] A threadlike adhesive sticking apparatus including:
a nozzle (10) having an inner wall surface (73) defining a cylindrical internal space (cylindrical internal space 71) and a tip end (77) having a tip end opening (75) at one end of the inner wall surface (73), the tip end opening (75) allowing the cylindrical internal space (cylindrical internal space 71) to communicate with an outside, in which
a peripheral portion (81) surrounding the tip end opening (75) at the tip end (77) functions as a pressing unit (83) that presses a threadlike adhesive (1), which is allowed to pass through the cylindrical internal space (cylindrical internal space 71) and is led out to the outside from the tip end opening (75), against an object (W), and
a value obtained by multiplying a thickness (A) of a surface functioning as the pressing unit (83) of the peripheral portion (81) and a numerical value 0.6 times a diameter (B) of a smallest-diameter portion (79) of the tip end opening (75) is 0.3 mm² or more and 3.0 mm² or less.

[2] The threadlike adhesive sticking apparatus according to [1], further including:
a nozzle displacement unit (nozzle attachment portion 19) attached to the nozzle (10) and configured to displace the nozzle (10) by being displaced in a pressing direction; and
an absorption mechanism (springs 43 and 45) configured to absorb a displacement of the nozzle (10) with respect to a displacement of the nozzle displacement unit (nozzle attachment portion 19) in the pressing direction.

[3] The threadlike adhesive sticking apparatus according to [1] or [2], in which
a value obtained by multiplying the thickness (A) of the surface functioning as the pressing unit (83) of the peripheral portion (81) and a numerical value 1.5 times an average outer diameter (C) of the threadlike adhesive (1) is 0.3 mm² or more and 3.0 mm² or less.

[4] The threadlike adhesive sticking apparatus according to any one of [1] to [3], in which
the thickness (A) of the surface functioning as the pressing unit (83) of the peripheral portion (81) is 0.5 mm or more and 10.0 mm or less.

[5] The threadlike adhesive sticking apparatus according to any one of [1] to [4], in which
a length (D) of the smallest-diameter portion (79) is 1 mm or more and less than 30 mm.

[6] The threadlike adhesive sticking apparatus according to [5], in which
the length (D) of the smallest-diameter portion (79) is 1 mm or more and less than 3 mm.

[7] The threadlike adhesive sticking apparatus according to any one of [1] to [6], in which
an inner diameter (E) of the internal space (cylindrical internal space 71) is 1.1 times or more to 5.0 times or less the diameter B of the smallest-diameter portion (79).

[8] The threadlike adhesive sticking apparatus according to any one of [1] to [7], in which
a chamfer (85) is formed on a corner of the smallest-diameter portion (75) on a tip end opening (79) side in a peripheral direction of the nozzle (10).

[9] The threadlike adhesive sticking apparatus according to any one of [1] to [8], in which
a chamfer (87) is formed on a corner of the smallest-diameter portion (79) on an internal space (cylindrical internal space 71) side in a peripheral direction of the nozzle (10).

[10] A method of sticking a threadlike adhesive including:
sticking the threadlike adhesive (1) to an object (W) using the threadlike adhesive sticking apparatus (100) according to any one of [1] to [9].

[11] The method of sticking a threadlike adhesive according to [10], in which
a pushing force to the threadlike adhesive (1) applied during sticking to the object (W) is set to 0.03 N·sec/mm² or more and 0.6 N·sec/mm² or less, and a friction force applied to the threadlike adhesive (1) is set to 2.0 N or more and 6.0 N or less.

[12] The method of sticking a threadlike adhesive according to [11], in which
a pushing force to the threadlike adhesive (1) applied during sticking to the object (W) is set to 0.1 N·sec/mm² or more and 0.6 N·sec/mm² or less, and a friction force applied to the threadlike adhesive (1) is set to 2.0 N or more and 6.0 N or less.

### EXAMPLE

### (Evaluation of Sticking)

The threadlike adhesive 1 was stuck to the object W by the nozzle 10, and a start point sticking property, a straight section sticking property, and a curved section sticking property with respect to the object W were evaluated. The evaluation of sticking was performed for Examples 1 to 10 and Comparative Examples 1 and 2, in which the threadlike adhesive 1 was stuck to the object W under various sticking conditions using the nozzle 10 of different dimensions and materials. In addition, regarding Examples 1 to 10 and Comparative Examples 1 and 2, a friction force between the nozzle 10 and the threadlike adhesive 1, a friction force per unit length between the nozzle 10 and the threadlike adhesive 1, and an adhesive force to the object W were measured. Setting conditions, calculated values, and evaluation results of the nozzle 10 are shown in Tables 1 and 2. In Examples 1, 4, 8, 9, and 10, and Comparative Example 2, a standard test plate made of acrylonitrile-butadiene-styrene copolymer (ABS) was used as the object W, in Example 2, a non-silicone separator (manufactured by Toyobo Co., Ltd., product number “TN200”) was used, and in Examples 3, 5, 6, and 7, and Comparative Example 1, a standard test plate made of SUS304BA was used.

In Table 1, the dimensions of the nozzle 10 are represented as shown in FIGS. 3 and 4, with A representing the thickness of the peripheral portion 81, B representing the diameter of the smallest-diameter portion 79, D representing the length of the smallest-diameter portion 79, and E representing the inner diameter of the cylindrical internal space 71. As shown in FIG. 3, while pushing the nozzle 10 toward the object W, the threadlike adhesive 1, which was passed through the cylindrical internal space 71 of the nozzle 10 and was pulled out of the tip end opening 75, was pulled sideways by a push-pull gauge, and tension in that case was taken as the friction force. The curved section sticking property was evaluated when the threadlike adhesive 1 was stuck along a curve with a curvature radius of 10 mm.

TABLE 1

| Setting condition | Example 1 | Example 2 | Example 3 | Example 4 | Example 5 |
|---|---|---|---|---|---|
| Material of nozzle | PTFE | PTFE | Iron | PTFE | Aluminum |
| Surface treatment | — | — | Fluorine | — | Fluorine |
| Diameter B (mm) of smallest- | 1.0 | 1.0 | 1.0 | 1.5 | 1.0 |
| diameter portion | | | | | |
| Length D (mm) of smallest-diameter | 20 | 2 | 10 | 2 | 2.8 |
| portion | | | | | |
| Inner diameter E (mm) of cylindrical | 2.0 | 2.0 | 3.0 | 2.0 | 2.0 |
| internal space | | | | | |
| Chamfer on corner of tip end | None | Present | None | Present | Present |
| opening | | | | | |
| Thickness A (mm) of peripheral | 2.0 | 3.0 | 0.6 | 3.0 | 2.0 |
| portion | | | | | |
| Width (mm) of threadlike adhesive | 0.6 | 0.6 | 0.6 | 0.9 | 0.6 |
| when sticking | | | | | |
| Pushing load (N) | 2.2 | 2.2 | 1.5 | 2.2 | 1.5 |
| Sticking speed (mm/sec) | 20 | 10 | 20 | 20 | 20 |
| Calculated value | | | | | |
| A × 0.6B (mm²) | 1.2 | 1.8 | 0.36 | 2.7 | 1.2 |
| Pushing area (mm²) | 1.2 | 1.8 | 0.36 | 2.7 | 1.2 |
| Pushing pressure (N/mm²) | 1.8 | 1.2 | 4.2 | 0.8 | 1.3 |
| Pushing time (sec) | 0.10 | 0.30 | 0.03 | 0.15 | 0.10 |
| Pushing force (N · sec/mm²) | 0.18 | 0.37 | 0.13 | 0.12 | 0.13 |
| Evaluation result | | | | | |
| Friction force (N) | 3.4 | 2.4 | 4.8 | 3.8 | 3.5 |
| Friction force per unit length (N/mm) | 5.7 | 4.0 | 8.0 | 4.2 | 5.8 |
| Material of object | ABS | TN200 | SUS304BA | ABS | SUS304BA |
| Adhesive force (N) to object | 0.52 | 0.25 | 0.59 | 0.97 | 0.59 |
| Start point sticking property | Good | Good | Good | Good | Good |
| Straight section sticking property | Good | Good | Good | Good | Good |
| Curved section sticking property | Good | Good | Good | Good | Good |

| | | | Comparative | Comparative |
|---|---|---|---|---|
| Setting condition | Example 6 | Example 7 | Example 1 | Example 2 |
| Material of nozzle | PTFE | PTFE | Iron | PTFE |
| Surface treatment | — | — | Fluorine | — |
| Diameter B (mm) of smallest- | 0.8 | 0.8 | 0.7 | 2.0 |
| diameter portion | | | | |
| Length D (mm) of smallest-diameter | 2 | 2 | 10 | 5 |
| portion | | | | |
| Inner diameter E (mm) of cylindrical | 2.0 | 2.0 | 3.0 | 3.0 |
| internal space | | | | |
| Chamfer on corner of tip end | Present | Present | None | Present |
| opening | | | | |
| Thickness A (mm) of peripheral | 2.0 | 3.0 | 0.6 | 4.0 |
| portion | | | | |
| Width (mm) of threadlike adhesive | 0.6 | 0.3 | 0.3 | 0.9 |
| when sticking | | | | |
| Pushing load (N) | 4.0 | 1.5 | 1.0 | 1.5 |
| Sticking speed (mm/sec) | 30 | 10 | 20 | 20 |
| Calculated value | | | | |
| A × 0.6B (mm²) | 0.96 | 1.44 | 0.25 | 4.8 |
| Pushing area (mm²) | 1.2 | 0.9 | 0.18 | 3.6 |
| Pushing pressure (N/mm²) | 3.3 | 1.7 | 5.6 | 0.4 |
| Pushing time (sec) | 0.07 | 0.30 | 0.03 | 0.20 |
| Pushing force (N · sec/mm²) | 0.22 | 0.50 | 0.17 | 0.08 |
| Evaluation result | | | | |
| Friction force (N) | 5.6 | 2.6 | 8.1 | 7.3 |
| Friction force per unit length (N/mm) | 9.3 | 8.7 | 27.0 | 8.1 |
| Material of object | SUS304BA | SUS304BA | SUS304BA | ABS |
| Adhesive force (N) to object | 0.59 | 0.28 | 0.28 | 0.97 |
| Start point sticking property | Good | Good | Poor | Good |
| Straight section sticking property | Good | Good | Good | Good |
| Curved section sticking property | Good | Good | Poor | Poor |

TABLE 2

| Setting condition | Example 8 | Example 9 | Example 10 |
|---|---|---|---|
| Material of nozzle | PTFE | PTFE | PTFE |
| Surface treatment | — | — | — |
| Diameter B (mm) of smallest-diameter portion | 1.0 | 0.8 | 1.0 |
| Length D (mm) of smallest-diameter portion | 10 | 10 | 20 |
| Inner diameter E (mm) of cylindrical internal | 2.0 | 4.0 | 2.0 |
| space | | | |
| Chamfer on corner of tip end opening | None | Present | Present |
| Thickness A (mm) of peripheral portion | 2.0 | 2.0 | 2.0 |
| Width (mm) of threadlike adhesive when | 0.6 | 0.6 | 0.6 |
| sticking | | | |
| Pushing load (N) | 2.2 | 2.2 | 2.2 |
| Sticking speed (mm/sec) | 90 | 70 | 70 |
| Calculated value | | | |
| A × 0.6B (mm²) | 1.2 | 0.96 | 1.2 |
| Pushing area (mm²) | 1.2 | 1.2 | 1.2 |
| Pushing pressure (N/mm²) | 1.8 | 1.8 | 1.8 |
| Pushing time (sec) | 0.02 | 0.03 | 0.03 |
| Pushing force (N · sec/mm²) | 0.04 | 0.05 | 0.05 |
| Evaluation result | | | |
| Friction force (N) | 3.1 | 3.8 | 4.0 |
| Friction force per unit length (N/mm) | 5.2 | 6.3 | 6.7 |
| Material of object | ABS | ABS | ABS |
| Adhesive force (N) to object | 0.54 | 0.56 | 0.56 |
| Start point sticking property | Good | Good | Good |
| Straight section sticking property | Good | Good | Good |
| Curved section sticking property | Good | Good | Good |

As shown in Tables 1 and 2, Examples 1 to 10 in which a value of A×0.6B was in a range of 0.3 mm² or more and 3.0 mm² or less were good in all of the start point sticking property, the straight section sticking property, and the curved section sticking property. In these Examples 1 to 10, a value (pushing area) obtained by multiplying the thickness A of the surface functioning as the pressing unit 83 of the peripheral portion 81 by a numerical value 1.5 times the average outer diameter C of the threadlike adhesive 1 was in a range of 0.3 mm² or more and 3.0 mm² or less. That is, since the pushing area of the threadlike adhesive 1 onto the object W was within an appropriate range, it was considered that an appropriate adhesive force can be obtained at all of a sticking start point, a straight section, and a curved section. In particular, in Example 2, it was found that the threadlike adhesive 1 could be stuck well to the object W made of TN200 having low adhesiveness in which a sheet made of polyethylene terephthalate (PET) resin was subjected to a silicone treatment. In addition, as shown in Tables 1 and 2, Examples 1 to 10, in which the pushing force applied to the threadlike adhesive 1 during sticking to the object was in a range of 0.03 N·sec/mm² to 0.6 N·sec/mm² and a friction force applied to the threadlike adhesive 1 was in a range of 2.0 N to 6.0 N, were good in all of the sticking start point, the straight section, and the curved section. In particular, in Examples 8 to 10 in which the nozzle 10 made of polytetrafluoroethylene (PTFE) was used, sticking was good even when the pressing force was small and a sticking speed was increased.

In this regard, in Comparative Example 1 in which the value of A×0.6B was 0.25 mm² less than 0.3 mm², the straight section sticking property was good, but the start point sticking property and curved section sticking property were poor. In this way, in Comparative Example 1, the thickness A of the peripheral portion 81 of the nozzle 10 was small, and thus the pushing area was 0.18 mm² less than 0.3 mm², and could not be sufficiently secured, and it was considered that the sticking of the threadlike adhesive 1 at the start point was particularly difficult. Also, in Comparative Example 2 in which the value of A×0.6B was 4.8 mm² greater than 3.0 mm², the start point sticking property and straight section sticking property were good, but the curved section sticking property was poor. In this way, in Comparative Example 2, the thickness A of the peripheral portion 81 of the nozzle 10 was large, and thus the pushing area of the threadlike adhesive 1 was 3.6 mm² greater than 3.0 mm², and the friction force between the nozzle 10 and the threadlike adhesive 1 became large with respect to the adhesive force between the object W and the threadlike adhesive 1, and it was considered that the accuracy was particularly poor at the curved section.

Although various embodiments have been described above with reference to the drawings, the present invention is not limited to these examples. It is apparent to those skilled in the art that various alterations or modifications can be conceived within the scope described in the claims, and it is understood that the alterations or modifications naturally fall within the technical scope of the present invention. In addition, the components described in the above embodiments may be freely combined without departing from the spirit of the invention.

The present application is based on a Japanese patent application (No. 2023-054109) filed on Mar. 29, 2023, the contents of which are incorporated as a reference in the present application.

### REFERENCE SIGNS LIST

1: threadlike adhesive
10: nozzle
19: nozzle attachment portion (nozzle displacement unit)
43, 45: spring (absorption mechanism)
71: cylindrical internal space (internal space)
73: inner wall surface
75: tip end opening
77: tip end
79: smallest-diameter portion
81: peripheral portion
83: pressing unit
85, 87: chamfer
100: threadlike adhesive sticking apparatus
A: thickness
B: diameter of smallest-diameter portion
C: average outer diameter of threadlike adhesive
D: length of smallest-diameter portion
E: inner diameter of cylindrical internal space
W: object

1. A threadlike adhesive sticking apparatus comprising:
a nozzle having an inner wall surface defining a cylindrical internal space and a tip end having a tip end opening at one end of the inner wall surface, the tip end opening allowing the internal space to communicate with an outside, wherein
a peripheral portion surrounding the tip end opening at the tip end functions as a pressing unit that presses a threadlike adhesive, which is allowed to pass through the internal space and is led out to the outside from the tip end opening, against an object, and
a value obtained by multiplying a thickness of a surface functioning as the pressing unit of the peripheral portion and a numerical value 0.6 times a diameter of a smallest-diameter portion of the tip end opening is 0.3 mm² or more and 3.0 mm² or less.

2. The threadlike adhesive sticking apparatus according to claim 1, further comprising:
a nozzle displacement unit attached to the nozzle and configured to displace the nozzle by being displaced in a pressing direction; and
an absorption mechanism configured to absorb a displacement of the nozzle with respect to a displacement of the nozzle displacement unit in the pressing direction.

3. The threadlike adhesive sticking apparatus according to claim 1, wherein
a value obtained by multiplying the thickness of the surface functioning as the pressing unit of the peripheral portion and a numerical value 1.5 times an average outer diameter of the threadlike adhesive is 0.3 mm² or more and 3.0 mm² or less.

4. The threadlike adhesive sticking apparatus according to claim 1, wherein
the thickness of the surface functioning as the pressing unit of the peripheral portion is 0.5 mm or more and 10.0 mm or less.

5. The threadlike adhesive sticking apparatus according to claim 1, wherein
a length of the smallest-diameter portion is 1 mm or more and less than 30 mm.

6. The threadlike adhesive sticking apparatus according to claim 5, wherein
the length of the smallest-diameter portion is 1 mm or more and less than 3 mm.

7. The threadlike adhesive sticking apparatus according to claim 1, wherein
an inner diameter of the internal space is 1.1 times or more to 5.0 times or less the diameter of the smallest-diameter portion.

8. The threadlike adhesive sticking apparatus according to claim 1, wherein
a chamfer is formed on a corner of the smallest-diameter portion on a tip end opening side in a peripheral direction of the nozzle.

9. The threadlike adhesive sticking apparatus according to claim 1, wherein
a chamfer is formed on a corner of the smallest-diameter portion on an internal space side in a peripheral direction of the nozzle.

10. A method of sticking a threadlike adhesive, comprising:
sticking the threadlike adhesive to an object using the threadlike adhesive sticking apparatus according to claim 1.

11. The method of sticking a threadlike adhesive according to claim 10, wherein
a pushing force to the threadlike adhesive applied during sticking to the object is set to 0.03 N·sec/mm² or more and 0.6 N·sec/mm² or less, and a friction force applied to the threadlike adhesive is set to 2.0 N or more and 6.0 N or less.

12. The method of sticking a threadlike adhesive according to claim 11, wherein
the pushing force to the threadlike adhesive applied during sticking to the object is set to 0.1 N·sec/mm² or more and 0.6 N·sec/mm² or less, and the friction force applied to the threadlike adhesive is set to 2.0 N or more and 6.0 N or less.
